(19) United States
(12) Patent Application Publication
(10) Pub. No.: US 2020/0379577 A1
(43) Pub. Date: Dec. 3, 2020

(54) KEYBOARD DEVICE AND COMPUTER CONTROL SYSTEM THEREOF

(71) Applicant: TAI-SHENG HAN, New Taipei (TW)

(72) Inventor: TAI-SHENG HAN, New Taipei (TW)

(21) Appl. No.: 16/429,376

(22) Filed: Jun. 3, 2019

(51) Int. Cl. G06F 3/023

(52) U.S. Cl. CPC G06F 3/023

(57) ABSTRACT

A keyboard device and a computer control system thereof, comprising a keyboard and an optical sensing module. The keyboard has electrically connected keys, light-emitting component and keyboard processing unit set with an initial setting command. The optical sensing module is disposed on the keyboard and electrically connected to the keyboard processing unit, and has a light source emitting unit generating a sensing signal, and a light source receiving unit. The keyboard processing unit transmits the sensing signal to a host processing unit of a host computer. Thereby, the optical sensing module senses that a user approaches the keyboard or generation of gestures to generate the sensing signal. The keyboard processing unit drives the light-emitting component to generate an initial light source. The host processing unit generates an advanced control signal to drive the light-emitting component, an operation unit and peripheral devices to generate advanced actions of an advanced setting command.

### BACKGROUND OF THE INVENTION

### Field of Invention

The present invention relates to a keyboard device and a computer control system thereof, and more particularly to a keyboard device and a computer control system thereof that automatically cause a keyboard to generate a light source as well as a computer and computer peripherals to generate actions through optical sensing to improve the use experience.

### Related Art

In this era of technology explosion, people rely on a variety of electronic products to make life more convenient and diverse, and use electronic products to improve efficiency and productivity to save a considerable amount of time. Among the electronic products, computer device has already become one of the indispensable and important tools in people's lives, and besides the host computer as the main equipment of a computer device, the keyboard is also a very important equipment for the computer device. The keyboard refers to a set of keys arranged through the system for operating a machine or equipment, the main function is to input data, which can be used to input characters, and can also be used to control the operation of the computer. The keyboard is composed of a plurality of keys, the keys are printed with symbols on them, and a user can press a key to print a corresponding symbol, such as letters, numbers or punctuations, etc. When using the computer device or the keyboard, the user needs to use a specific software or a specific key on the keyboard to drive the computer or control a specific function on the keyboard or to drive peripheral devices to activate behaviors such as light effects of the keyboard or wake-up of the computer. However, in the current technology, the user needs to touch the keyboard with both hands and operate in order to achieve the above objects, and thus causing the user being unable to experience the activation by automatic sensing.

Therefore, how to solve the above problems and drawbacks in the prior art is what the inventor of the present invention and relevant manufacturers engaged in this industry are eager to research and make improvement.

### SUMMARY OF THE INVENTION

Therefore, in order to effectively solve the above problems, a main object of the present invention is to provide a keyboard device and a computer control system thereof that automatically cause a keyboard to generate a light source as well as a computer and computer peripherals to generate actions through optical sensing to improve the use experience.

In order to achieve the above object, the present invention provides a keyboard device comprising a keyboard and an optical sensing module, wherein the keyboard is formed with an operation surface at an upper side position, and two sides of the operation surface respectively have a long side, one of the long sides is a far side away from a user, the other long side is an adjacent side adjacent to the user, and the operation surface is provided with a plurality of keys and at least one light-emitting component. Inside the keyboard is disposed with a keyboard processing unit, the keyboard processing unit is electrically connected to the keys and the light-emitting component, and an initial setting command is set in the keyboard processing unit. The keyboard processing unit is capable of generating at least one initial control signal according to the initial setting command. The optical sensing module is disposed at a position of the adjacent side of the keyboard. The optical sensing module is electrically connected to the keyboard processing unit, and the optical sensing module has a light source emitting unit and a light source receiving unit, the light source emitting unit emits a light of a specific wavelength range, and the light source receiving unit receives a reflected light. The optical sensing module generates a sensing signal after the light source receiving unit receives the reflected light, and the sensing signal is transmitted to the keyboard processing unit, and the keyboard processing unit generates the initial control signal to drive the light-emitting component to generate an initial light source of the initial setting command. Whereby when the user approaches the keyboard device, the optical sensing module senses that the user approaches the keyboard or generation of gestures to generate the sensing signal, and the keyboard processing unit drives the light-emitting component to generate the initial light source of the initial setting command, and thus achieving the effect of automatically causing the keyboard to generate a light source to improve the use experience.

According to an embodiment of the keyboard device of the present invention, wherein the keyboard further has a signal transmission interface, and the signal transmission interface is electrically connected to the keyboard processing unit.

The present invention further provides a computer control system comprising a host computer, a keyboard and an optical sensing module, wherein the host computer has a plurality of signal connection interfaces, a host processing unit and at least one operation unit. The signal connection interfaces are electrically connected to the host processing unit, and the host processing unit has an advanced setting command and is capable of generating at least one advanced control signal according to the advanced setting command. The keyboard is electrically connected to the host computer, the keyboard is formed with an operation surface at an upper side position, and two sides of the operation surface respectively have a long side, one of the long sides is a far side away from a user, the other long side is an adjacent side adjacent to the user, and the operation surface is provided with a plurality of keys and at least one light-emitting component. Inside the keyboard is disposed with a keyboard processing unit, the keyboard processing unit is electrically connected to the keys and the light-emitting component, and an initial setting command is set in the keyboard processing unit. The keyboard processing unit is capable of generating at least one initial control signal according to the initial setting command. The optical sensing module is disposed at a position of the adjacent side of the keyboard. The optical sensing module is electrically connected to the keyboard processing unit, and the optical sensing module has a light source emitting unit and a light source receiving unit, the light source emitting unit emits a light of a specific wavelength range, and the light source receiving unit receives a reflected light. The optical sensing module generates a sensing signal after the light source receiving unit receives the reflected light, and the sensing signal is transmitted to the keyboard processing unit, and the keyboard processing unit generates the initial control signal to drive the light-emitting component to generate an initial light source of the initial setting command. The keyboard processing unit transmits the sensing signal to the host processing unit of the host computer, and the host processing unit generates the advanced control signal to drive the operation unit to generate actions of the advanced setting command. Whereby when the user approaches the keyboard device, the optical sensing module senses that the user approaches the keyboard or generation of gestures to generate the sensing signal, and the keyboard processing unit drives the light-emitting component to generate the initial light source of the initial setting command, and the host processing unit generates the advanced control signal to drive the operation unit to generate an advanced light source of the advanced setting command, and thus achieving the effects of automatically causing the keyboard to generate the advanced light source and the host computer to generate actions to improve the use experience.

According to an embodiment of the computer control system of the present invention, wherein the keyboard processing unit transmits the sensing signal to the signal connection interfaces of the host computer via the signal transmission interface, and the signal connection interfaces transmit the sensing signal to the host processing unit.

According to an embodiment of the computer control system of the present invention, wherein the keyboard processing unit transmits the sensing signal to the host processing unit of the host computer, and the host processing unit generates the advanced control signal to drive the light-emitting component to generate the advanced light source of the advanced setting command.

According to an embodiment of the computer control system of the present invention, wherein the host processing unit transmits the advanced control signal to the signal transmission interface of the keyboard via the signal connection interfaces, the signal transmission interface transmits the advanced control signal to the keyboard processing unit, and the keyboard processing unit drives the light-emitting component to generate the advanced light source of the advanced setting command.

According to an embodiment of the computer control system of the present invention, wherein the host processing unit generates the advanced control signal to drive the operation unit to generate the actions of the advanced setting command.

According to an embodiment of the computer control system of the present invention, further comprising at least one peripheral device, the peripheral device having a signal receiving interface and a device processing unit, wherein the signal receiving interface is electrically connected to the signal connection interfaces, the keyboard processing unit transmits the sensing signal to the host processing unit of the host computer, and the host processing unit generates the advanced control signal to drive the peripheral device to generate the actions of the advanced setting command.

According to an embodiment of the computer control system of the present invention, wherein the host processing unit transmits the advanced control signal to the signal receiving interface of the peripheral device via the signal connection interfaces, the signal receiving interface transmits the advanced control signal to the device processing unit, and the device processing unit drives the peripheral device to generate the actions of the advanced setting command.

### BRIEF DESCRIPTION OF THE DRAWINGS

FIG. 1 is a perspective view of a keyboard device of the present invention;

FIG. 2 is a block diagram of the keyboard device of the present invention;

FIG. 3 is a first schematic view of the implementation of the keyboard device of the present invention;

FIG. 4 is a second schematic view of the implementation of the keyboard device of the present invention;

FIG. 5 is a perspective view of a computer control system of the present invention;

FIG. 6 is a block diagram of the computer control system of the present invention;

FIG. 7 is a first schematic view of the implementation of the computer control system of the present invention;

FIG. 8 is a second schematic view of the implementation of the computer control system of the present invention;

FIG. 9 is a third schematic view of the implementation of the computer control system of the present invention; and

FIG. 10 is a block diagram of the implementation of the computer control system of the present invention.

### DETAILED DESCRIPTION OF THE INVENTION

The above objects and structural and functional features of the present invention will be described in accordance with the preferred embodiments with reference to the accompanying drawings.

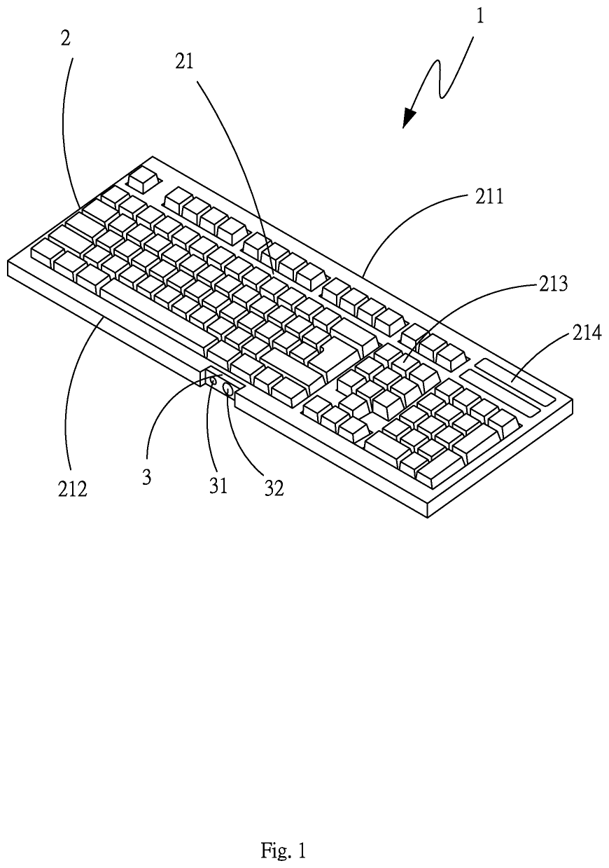

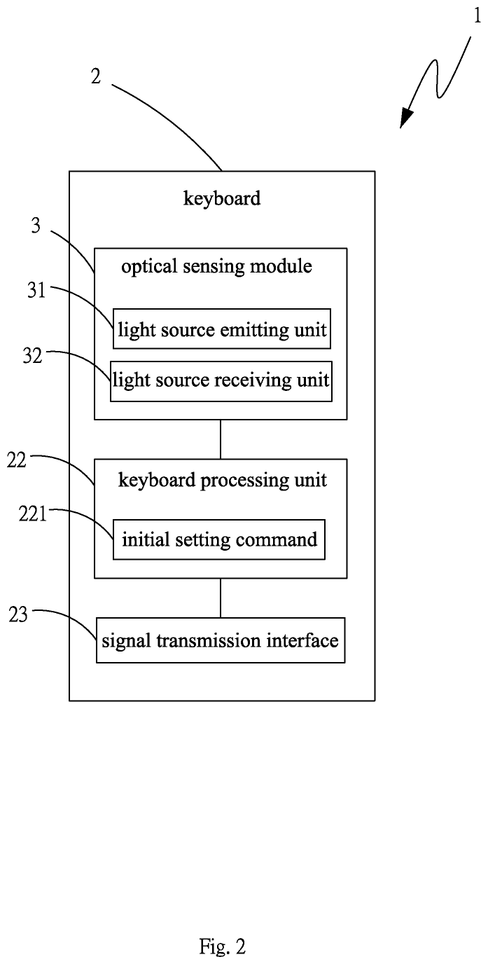

Please refer to FIG. 1 and FIG. 2, which are perspective view and block diagram of a keyboard device 1 of the present invention. It can be clearly seen from the figures that, the keyboard device 1 comprises a keyboard 2 and an optical sensing module 3.

The keyboard 2 is formed with an operation surface 21 at an upper side position and disposed with a keyboard processing unit 22 therein. Sides of the operation surface 21 can be divided into long sides and short sides, one of the long sides of the operation surface 21 is a far side 211, and the other long side of the operation surface 21 is an adjacent side 212; the far side 211 is away from a user, and the adjacent side 212 is adjacent to the user. The operation surface 21 is provided with a plurality of keys 213 and at least one light-emitting component 214, and the keys 213 and the light-emitting component 214 are electrically connected to the keyboard processing unit 22. The light-emitting component 214 can be a light-emitting element of the keys 213, or a light-emitting element on the operation surface 21, or a light-emitting element around the keyboard 2, or another light-emitting element on the keyboard 2. The keyboard processing unit 22 is set with an initial setting command 221, the keyboard 2 further has a signal transmission interface 23, and the signal transmission interface 23 is electrically connected to the keyboard processing unit 22.

The optical sensing module 3 is disposed at a position of the adjacent side 212 of the keyboard 2, and the optical sensing module 3 can be set with an sensing angle according to the shape of the keyboard 2. In this embodiment, the sensing angle of the optical sensing module 3 is a small angle between the optical sensing module 3 and a desktop. Contrarily, if the keyboard 2 has a wrist rest, the sensing angle of the optical sensing module 3 needs to avoid the wrist rest and is a large angle between the optical sensing module 3 and the desktop. The optical sensing module 3 is electrically connected to the keyboard processing unit 22, and the optical sensing module 3 has a light source emitting unit 31 and a light source receiving unit 32. Wherein the light source emitting unit 31 is capable of emitting a laser light of a specific wavelength range, the light source receiving unit 32 receives a reflected light of the laser light, and a range in which the light source receiving unit 32 receives the reflected light is larger than a range in which the light source emitting unit 31 emits the light irradiation.

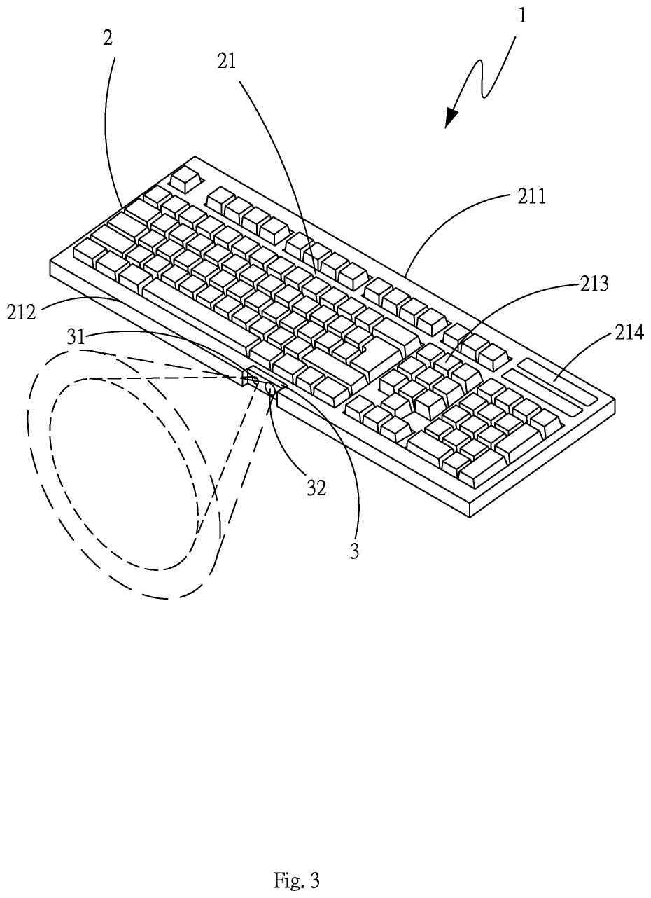

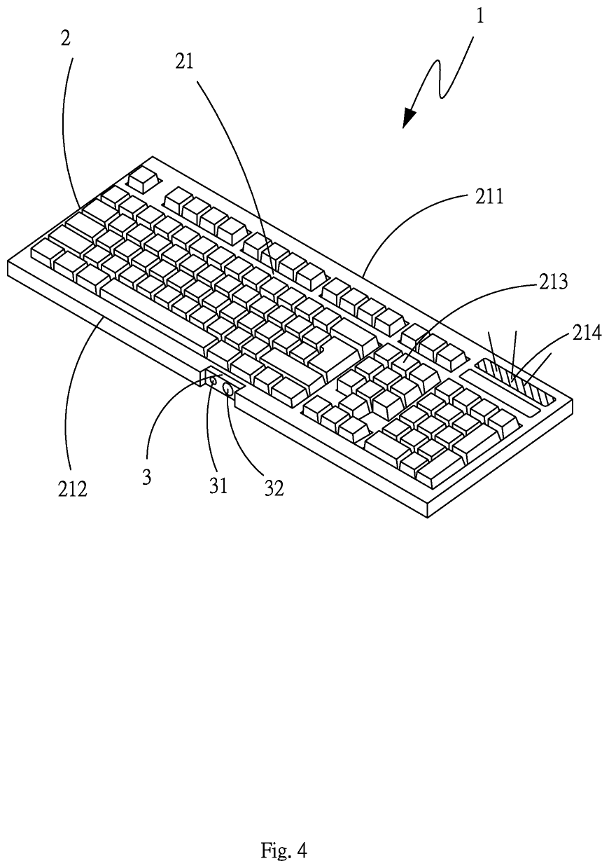

Referring to the foregoing drawings and FIGS. 3 and 4 as well, which are first schematic view and second schematic view of the implementation of the keyboard device 1 of the present invention. When the keyboard device 1 is in use, the light source emitting unit 31 continuously emits a laser light of a specific wavelength range, and the light source receiving unit 32 receives a reflected light of the laser light. When the user approaches the adjacent side 212 of the keyboard device 1 or gestures near the adjacent side 212, the light source receiving unit 32 receives the reflected light reflected by the user or receives the gestures by the reflected light. The optical sensing module 3 generates a sensing signal after the light source receiving unit 32 receives the reflected light, the sensing signal is transmitted to the keyboard processing unit 22, and the keyboard processing unit 22 generates an initial control signal to drive the light-emitting component 214 to generate an initial light source of an initial setting command. Wherein the initial light source can be a fixed light source or an action light source, the fixed light source is a light source of monochromatic illumination, and the action light source can be a light source that is not only a simple light, such as a flashing light or an electronic scroll or a change in the color of the light. Thereby when the user approaches the keyboard device 1, the optical sensing module 3 senses that the user approaches the keyboard 2 or generation of gestures to generate the sensing signal, and the keyboard processing unit 22 drives the light-emitting component 214 to generate the initial light source of the initial setting command, and thus achieving the effect of automatically causing the keyboard 2 to generate the light source to improve the use experience.

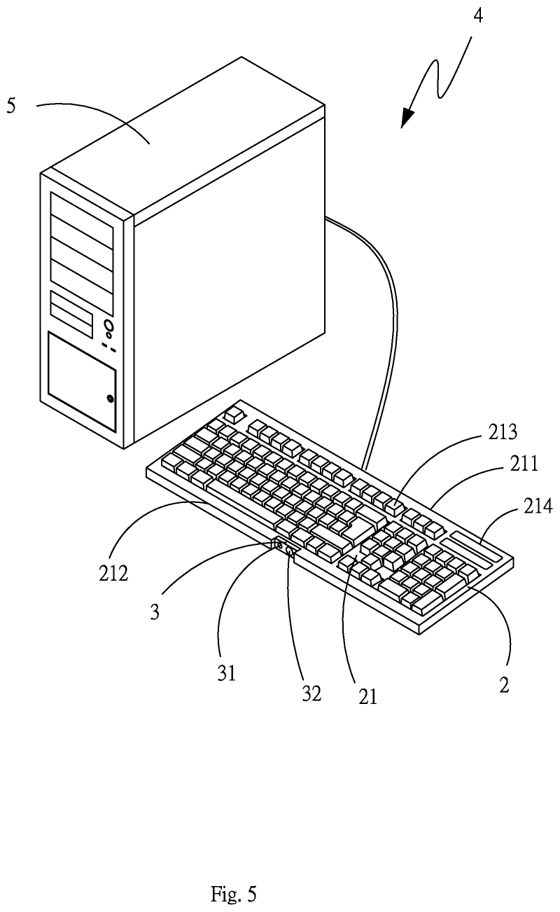

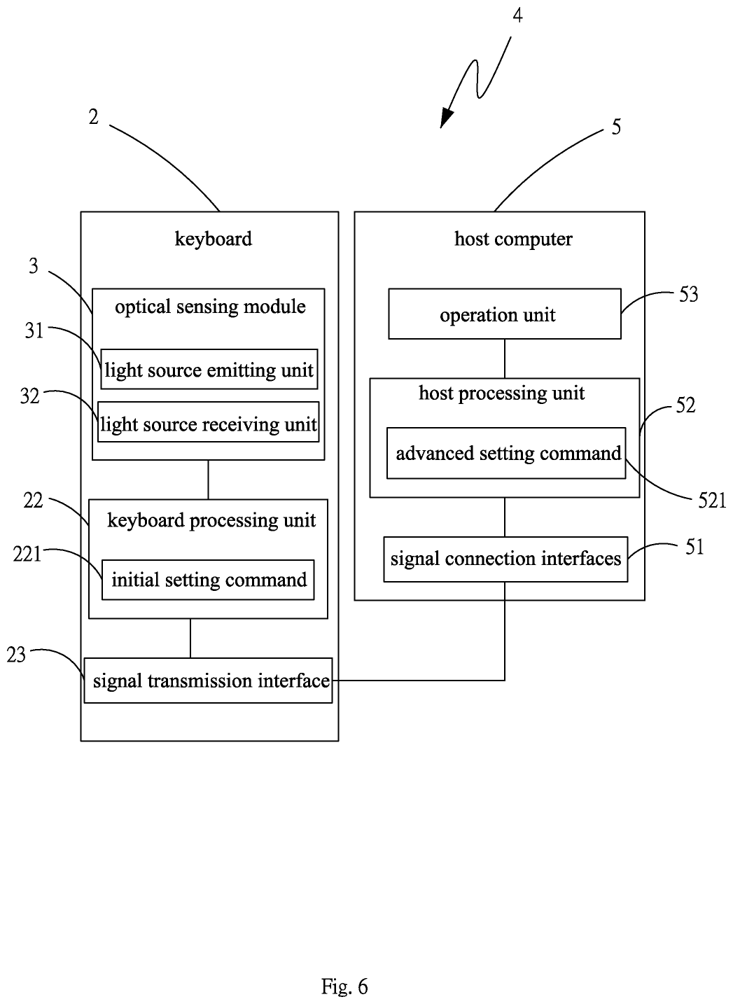

Please refer to FIG. 5 and FIG. 6, which are perspective view and block diagram of a computer control system 4 of the present invention. It can be clearly seen from the figures that the computer control system 4 comprises a host computer 5, the keyboard 2 and the optical sensing module 3.

The host computer 5 has a plurality of signal connection interfaces 51, a host processing unit 52 and at least one operation unit 53. The signal connection interfaces 51 are electrically connected to the host processing unit 52. The host processing unit 52 is provided with an advanced setting command 521, actions of the advanced setting command 521 can be activating, deactivating, continuing, or the like, or the actions of the advanced setting command 521 can activate a light-emitting element on the operation unit 53 to generate an advanced light source. Wherein the keyboard 2 and the optical sensing module 3 are assembled and operated in the same manner as the above embodiment, and will not be further described herein. In addition, the signal transmission interface 23 of the keyboard 2 is electrically connected to the signal connection interfaces 51 of the host computer 5.

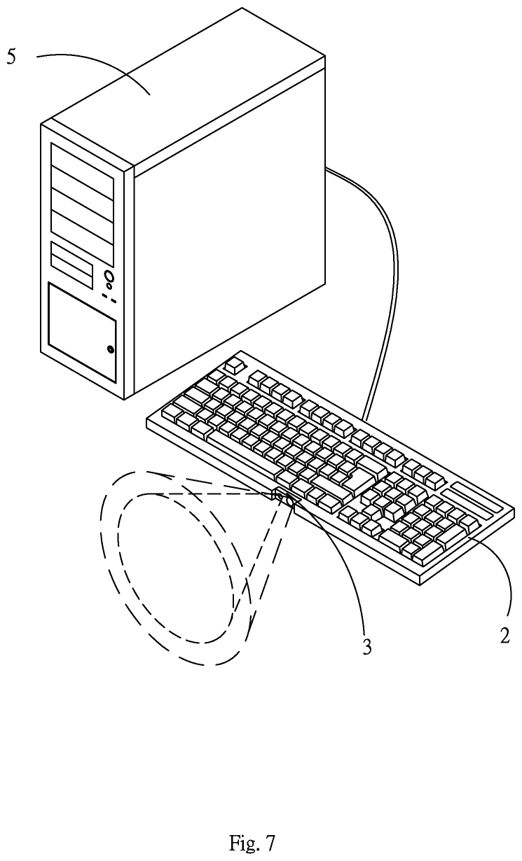

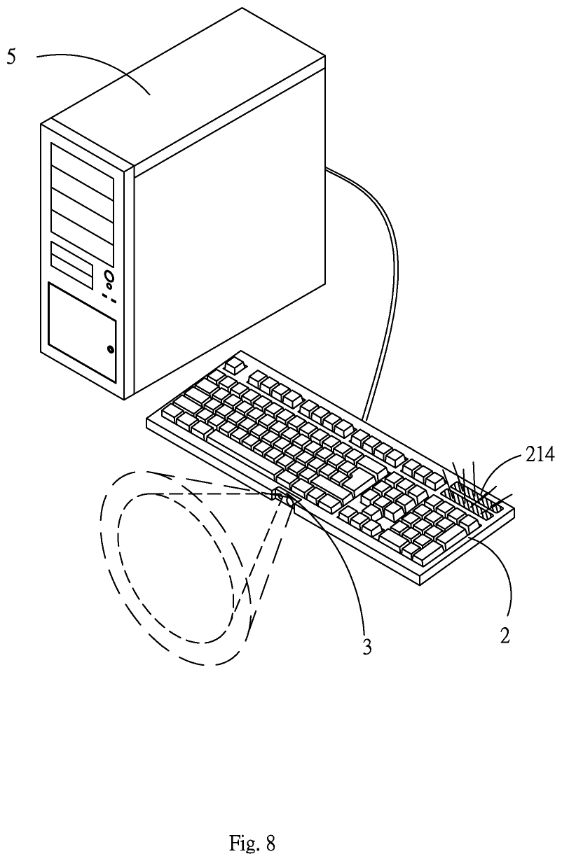

Referring to the foregoing drawings and FIGS. 7 and 8 as well, which are first schematic view and second schematic view of the implementation of the computer control system 4 of the present invention. When the computer control system 4 is in use, the light source emitting unit 31 continuously emits a laser light of a specific wavelength range, and the light source receiving unit 32 receives a reflected light of the laser light. If the user approaches the adjacent side 212 of the keyboard device 1 or gestures near the adjacent side 212, the light source receiving unit 32 receives the reflected light reflected by the user or receives the gestures by the reflected light. The optical sensing module 3 generates a sensing signal after the light source receiving unit 32 receives the reflected light, the sensing signal is transmitted to the keyboard processing unit 22, and the keyboard processing unit 22 generates the initial control signal to drive the light-emitting component 214 to generate the initial light source of the initial setting command. The keyboard processing unit 22 transmits the sensing signal to the signal connection interfaces 51 of the host computer 5 via the signal transmission interface 23. The signal connection interfaces 51 transmit the sensing signal to the host processing unit 52, and the host processing unit 52 generates the advanced control signal to drive the operation unit 53 to generate the actions of the advanced setting command 521. The actions comprise the host processing unit 52 generates the advanced control signal to drive the light-emitting component 214 to generate the advanced light source of the advanced setting command 521, and the host processing unit 52 generates the advanced control signal to drive the operation unit 53 to generate the actions of the advanced setting command 521. Wherein the host processing unit 52 transmits the advanced control signal to the signal transmission interface 23 of the keyboard 2 via the signal connection interfaces 51. The signal transmission interface 23 transmits the advanced control signal to the keyboard processing unit 22, and the keyboard processing unit 22 drives the light-emitting component 214 to generate the advanced light source of the advanced setting command 521. The other action is the keyboard processing unit 22 transmits the sensing signal to the host processing unit 52 of the host computer 5, and the host processing unit 52 generates the advanced control signal to drive the operation unit 53 to generate the actions of the advanced setting command 521. Wherein the operation unit 53 can be a computer device disposed in the host computer 5 such as a CPU radiating module, a display card, a motherboard, a memory, a power supply, a fan, an independent sound card, and a cooling device, and the operation unit 53 is also provided with a light-emitting element capable of generating a light source. When the host processing unit 52 drives the operation unit 53 by the advanced control signal, the light-emitting elements on the operation units 53 generate the advanced light source of the advanced setting command 521. Wherein the advanced light source can be a fixed light source or an action light source, the fixed light source is a light source of monochromatic illumination, and the action light source can be a light source that is not only a simple light, such as a flashing light or an electronic scroll or a change in the color of the light. Thereby when the user approaches the keyboard device 1, the optical sensing module 3 senses that the user approaches the keyboard 2 or generation of gestures to generate the sensing signal, and the keyboard processing unit 22 drives the light-emitting component 214 to generate the initial light source of the initial setting command, and the host processing unit 52 generates the advanced control signal to drive the operation unit 53 to generate the advanced light source of the advanced setting command 521, and thus achieving the effects of automatically causing the keyboard 2 to generate the light source and the host computer 5 to generate actions to improve the use experience.

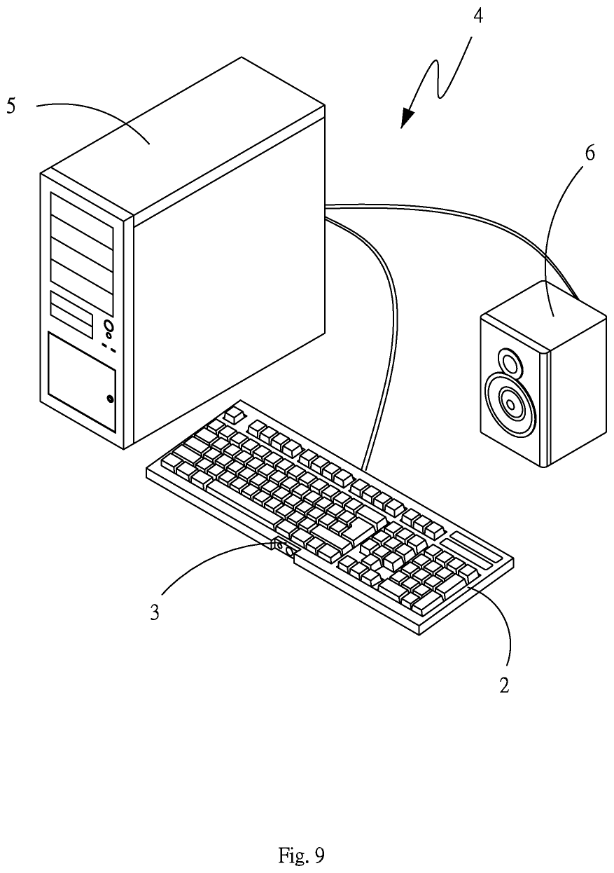

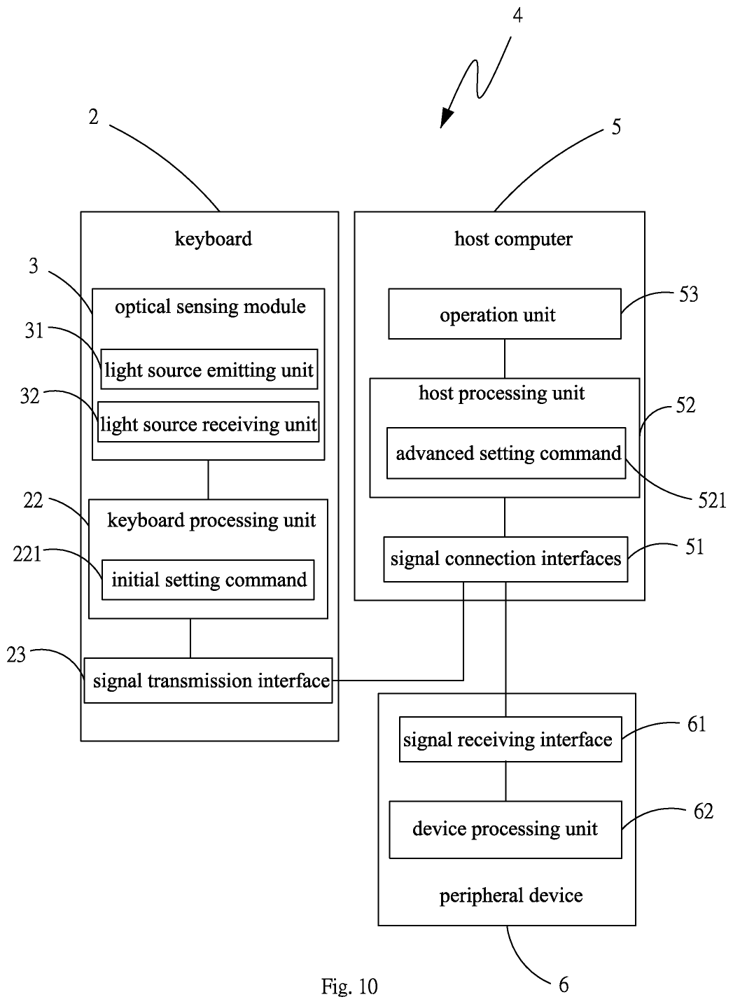

Please refer to the foregoing drawings and FIGS. 9 and 10 as well, which are third schematic view and block diagram of the implementation of the computer control system 4 of the present invention. The computer control system 4 further comprises at least one peripheral device 6, wherein the peripheral device 6 can be a peripheral device of wireless or wired transmission such as a mouse, a mouse pad, an earphone, a speaker, a printer, a monitor, an external light-emitting element. The peripheral device 6 has a signal receiving interface 61 and a device processing unit 62. The keyboard processing unit 22 transmits the sensing signal to the host processing unit 52 of the host computer 5, and the host processing unit 52 transmits the advanced control signal to the signal receiving interface 61 of the peripheral device 6 via the signal connection interfaces 51. The signal receiving interface 61 transmits the advanced control signal to the device processing unit 62, and the device processing unit 62 drives the peripheral device 6 to generate the actions of the advanced setting command 521, such as the mouse generating a light source of advanced action, or the speaker generating a sound effect of advanced action, or the printer generating a light source of advanced action, etc. Thereby when the user approaches the keyboard device 1, the optical sensing module 3 senses that the user approaches the keyboard 2 or generation of gestures to generate the sensing signal, the keyboard processing unit 22 drives the light-emitting component 214 to generate the initial light source of the initial setting command, the host processing unit 52 generates the advanced control signal to drive the operation unit 53 to generate the actions of the advanced setting command 521, and at the same time, the device processing unit 62 drives the peripheral device 6 to generate the actions of the advanced setting command 521. Thus achieving the effects of automatically causing the keyboard 2 to generate the light source as well as the host computer 5 and the peripheral device 6 to generate actions to improve the use experience.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

1. A keyboard device, comprising:
a keyboard, the keyboard being formed with an operation surface thereon, two sides of the operation surface being respectively formed with an adjacent side and a far side, the operation surface being provided with a plurality of keys and at least one light-emitting component, inside the keyboard being disposed with a keyboard processing unit electrically connected to the keys and the light-emitting component, and the keyboard processing unit having an initial setting command and being capable of generating at least one initial control signal according to the initial setting command; and
an optical sensing module, the optical sensing module being disposed at a position of the adjacent side and electrically connected to the keyboard processing unit, the optical sensing module having a light source emitting unit and a light source receiving unit, the light source emitting unit emitting a light of a specific wavelength range, after the light source receiving unit receiving a reflected light, the optical sensing module generating a sensing signal to the keyboard processing unit, and the keyboard processing unit generating the initial control signal to drive the light-emitting component to generate an initial light source of the initial setting command;
wherein a range in which the light source receiving unit receives the reflected light is larger than a range in which the light source emitting unit emits the light irradiation.

2. The keyboard device as claimed in claim 1, wherein the keyboard further has a signal transmission interface, and the signal transmission interface is electrically connected to the keyboard processing unit.

3. A computer control system, comprising:
a host computer, the host computer having a plurality of signal connection interfaces, a host processing unit and at least one operation unit, the signal connection interfaces being electrically connected to the host processing unit, and the host processing unit having an advanced setting command and being capable of generating at least one advanced control signal according to the advanced setting command;
a keyboard, the keyboard being electrically connected to the host computer, the keyboard being formed with an operation surface thereon and disposed with at least one signal transmission interface, two sides of the operation surface being respectively formed with an adjacent side and a far side, the operation surface being provided with a plurality of keys and at least one light-emitting component, inside the keyboard being disposed with a keyboard processing unit electrically connected to the keys and the light-emitting component, and the keyboard processing unit having an initial setting command and being capable of generating at least one initial control signal according to the initial setting command; and
an optical sensing module, the optical sensing module being disposed at a position of the adjacent side and electrically connected to the keyboard processing unit, the optical sensing module having a light source emitting unit and a light source receiving unit, the light source emitting unit emitting a light of a specific wavelength range, after the light source receiving unit receiving a reflected light, the optical sensing module generating a sensing signal to the keyboard processing unit, the keyboard processing unit generating the initial control signal to drive the light-emitting component to generate an initial light source of the initial setting command, the keyboard processing unit transmitting the sensing signal to the host processing unit of the host computer, and the host processing unit generating the advanced control signal to drive the operation unit to generate actions of the advanced setting command;
wherein a range in which the light source receiving unit receives the reflected light is larger than a range in which the light source emitting unit emits the light irradiation.

4. The computer control system as claimed in claim 3, wherein the keyboard processing unit transmits the sensing signal to the signal connection interfaces of the host computer via the signal transmission interface, and the signal connection interfaces transmit the sensing signal to the host processing unit.

5. The computer control system as claimed in claim 3, wherein the keyboard processing unit transmits the sensing signal to the host processing unit of the host computer, and the host processing unit generates the advanced control signal to drive the light-emitting component to generate an advanced light source of the advanced setting command.

6. The computer control system as claimed in claim 5, wherein the host processing unit transmits the advanced control signal to the signal transmission interface of the keyboard via the signal connection interfaces, the signal transmission interface transmits the advanced control signal to the keyboard processing unit, and the keyboard processing unit drives the light-emitting component to generate the advanced light source of the advanced setting command.

7. The computer control system as claimed in claim 6, wherein the host processing unit generates the advanced control signal to drive the operation unit to generate the actions of the advanced setting command.

8. The computer control system as claimed in claim 3, further comprising at least one peripheral device, the peripheral device having a signal receiving interface and a device processing unit, wherein the signal receiving interface is electrically connected to the signal connection interfaces, the keyboard processing unit transmits the sensing signal to the host processing unit of the host computer, and the host processing unit generates the advanced control signal to drive the peripheral device to generate the actions of the advanced setting command.

9. The computer control system as claimed in claim 8, wherein the host processing unit transmits the advanced control signal to the signal receiving interface of the peripheral device via the signal connection interfaces, the signal receiving interface transmits the advanced control signal to the device processing unit, and the device processing unit drives the peripheral device to generate the actions of the advanced setting command.

10. The computer control system as claimed in claim 9, wherein the peripheral device can be a device of wireless or wired transmission such as a mouse, a mouse pad, an earphone, a speaker, a printer, a monitor, an external light-emitting element, and the operation unit can be a unit disposed in the host computer such as a CPU radiating module, a display card, a motherboard, a memory, a power supply, a fan, an independent sound card, and a cooling device, and the operation units are provided with a light-emitting element capable of generating a light source.
